(19) United States
(12) Patent Application Publication
(10) Pub. No.: US 2024/0328141 A1
(43) Pub. Date: Oct. 3, 2024

(54) Method and Apparatus for Controlling Hazardous Materials Disposed Within a Storm Water Control System

(71) Applicant: Denis Friezner, Boise, ID (US)

(72) Inventor: Denis Friezner, Boise, ID (US)

(21) Appl. No.: 18/657,443

(22) Filed: May 7, 2024

Related U.S. Application Data
(63) Continuation-in-part of application No. 17/666,136, filed on Feb. 7, 2022, now Pat. No. 12,044,000.
(60) Provisional application No. 63/147,503, filed on Feb. 9, 2021.

(51) Int. Cl. E03F 5/14; B01D 35/02

(52) U.S. Cl. CPC E03F 5/14; B01D 35/02; B01D 2221/12

(57) ABSTRACT

An apparatus for preventing the escape of hazardous materials from fluid flow control systems of the character used by municipalities for carrying runoff storm water away from streets and populated areas.

### CROSS-REFERENCE TO RELATED APPLICATIONS

This is a Continuation-in-Part of Non-Provisional application Ser. No. 17/666,136 filed Feb. 7, 2022, which claims the benefit of co-pending Provisional Application No. 63/147,503 filed Feb. 9, 2021.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention relates generally to an apparatus for controlling the egress of hazardous materials from storm water control systems.

### Description of Related Art Including Information Disclosed Under 37 CFR 1.97 and 1.98

The control of excess runoff rain water has long been a problem faced by municipalities throughout the United States. Heavy rainfall can create large volumes of runoff that must be handled effectively in order to avoid flooding, that can result in road closures and substantial property damage. Accordingly, most municipalities have installed drain systems that include curbside drains that are provided at spaced apart locations along most thoroughfares. The curbside drains typically lead to main drain pipes that carry the water to adjacent rivers, directly to the ocean, or to remote catch basins.

While the prior art drain systems have, for the most part, proven effective in carrying runoff storm water away from the streets and populated areas, the control of natural debris and hazardous man-made debris entering the drain systems and remaining therein remains a major problem. For this reason, various attempts have been made in the past to prevent unwanted debris from entering into curbside drains. A highly successful system for preventing large volumes of unwanted debris from entering into curbside drains is described in U.S. Pat. No. 9,428,899 issued to the present inventor. Another somewhat similar prior art system is described in a Matthews U.S. Pat. No. 4,689,145. This patent describes a filtration system that comprises a buffer tank in the form of a generally elongated concrete box having a water inlet at one end and a water outlet at the other end. A baffle, which is provided in the tank extends from side-to-side and from the bottom to a predetermined distance from the top near the inlet pipe end of the tank end to prevent water flow in a straight line from the inlet pipe to the outlet. Unlike Applicant's system, filters are provided in the tank and extend from side-to-side and top to bottom, so that water passing through the tank must pass through the filters. The filters are located between the baffle and the water outlet to prevent particles of greater than a predetermined size from passing through the filters to the water outlet.

Debris that resides within the tubular portion of storm water control systems can cause numerous problems, including the buildup of hazardous gases that over time escape from the system, create foul smells, and causes various types of health hazards to persons exposed to the gases. Additionally, since the storm water structures temporarily, or permanently retain runoff water that keeps the debris moist, the storm water structures become ideal insect breeding areas.

Insect abatement and particularly mosquito abatement continues to present major nationwide problems. As recently observed by the American Mosquito Control Association, some sort of organized mosquito control programs exist at the state, county or city level. These programs include permanent measures such as draining swampy mosquito breeding areas and temporary measures such as aerosol spraying by ground or aerial equipment to kill adult and larval mosquitoes.

Mosquitoes can breed in any standing water, but they are particularly drawn to standing water containing substantial amounts of organic debris. Accordingly, storm water structures that temporarily, or permanently retain runoff water and organic debris require particular attention as likely mosquito breeding areas. It is a principal objective of the present invention to develop measures for the effective abatement of insects and particularly mosquitoes in such structures.

### BRIEF SUMMARY OF THE INVENTION

By way of brief summary, the present invention comprises methods and apparatus for controlling the egress of hazardous matter from storm water control systems. More particularly, the invention concerns apparatus for preventing the egress of hazardous gases from storm water control systems and for abatement of insects, including mosquitoes, that reside within the tubular portion of storm water control systems. One form of the method of the invention comprises the steps of covering the fluid outlet of the tubular drain portion of the apparatus with a barrier that will block the egress of hazardous gases therefrom, but will permit the free flow of liquid therethrough. The barrier can be constructed from various materials, but in the preferred form of the invention the barrier comprises a yieldably deformable butyl rubber. Another form of the method of the invention comprises the steps of covering both the fluid inlet and the fluid outlet of the tubular drain portion of the apparatus with a barrier that will block the egress of mosquitoes from the tubular drain portion but will permit the free flow of liquid therethrough. The barrier can be constructed from various materials, but in the preferred form of the invention the barrier comprises a yieldably deformable porous material having between 280 and 800 perforations per square inch. The porous material used to construct the barrier can comprise metal, cloth, plastic and the like.

With the forgoing in mind, it is a primary object of the invention to provide an apparatus for preventing the escape of hazardous materials from fluid flow control systems of the character used by municipalities for carrying runoff storm water away from streets and populated areas.

Another object of the invention is to provide an apparatus of the character that includes a porous barrier constructed from fabric or metal mesh that will block the egress of mosquitoes from the tubular drain portion of the fluid control system but will permit the free flow of liquid therethrough.

Another object of the invention is to provide an apparatus of the character described in the preceding paragraph in which the barrier material exhibits a porosity of between about 280 and about 800 perforations per square inch.

Another object of the invention is to provide an apparatus of the character described in which the barrier material is easy to install and in no way affects the structural integrity of the storm drain.

### BRIEF DESCRIPTION OF SEVERAL VIEWS OF THE DRAWINGS

FIG. 1 is a generally perspective view of one form of the apparatus of the invention for blocking the egress of hazardous gases from the tubular portion of a conventional storm water control system showing the barrier portions thereof disposed in a closed blocking orientation.

FIG. 2 is a generally perspective view similar to FIG. 1 but showing the barrier portion thereof disposed in an open orientation to permit the flow of liquids through the tubular portion.

FIG. 3. is a side elevational view of one form of the apparatus of the invention for blocking the egress of hazardous gases from the tubular portion of a conventional storm water control system showing the barrier portions thereof disposed in a closed blocking orientation.

FIG. 4 is a side elevational view similar to FIG. 3 but showing the barrier portion thereof disposed in an open orientation to permit the flow of liquids through the tubular portion.

FIG. 5 is a generally perspective view of another form of the apparatus of the invention for abatement of insects, including mosquitoes, that reside within the tubular portion of storm water control systems showing the barrier portions thereof disposed in a closed blocking orientation.

FIG. 6 is a generally perspective view similar to FIG. 5 but showing the barrier portion thereof disposed in an open orientation to permit the flow of liquids through the tubular portion.

FIG. 7 is a side elevational view of another form of the apparatus of the invention for abatement of insects, including mosquitoes, that reside within the tubular portion of storm water control systems showing the barrier portions thereof disposed in a closed blocking orientation.

FIG. 8 is a side elevational view similar to FIG. 7, but showing the barrier portion thereof disposed in an open orientation to permit the flow of liquids through the tubular portion.

### DETAILED DESCRIPTION OF THE INVENTION

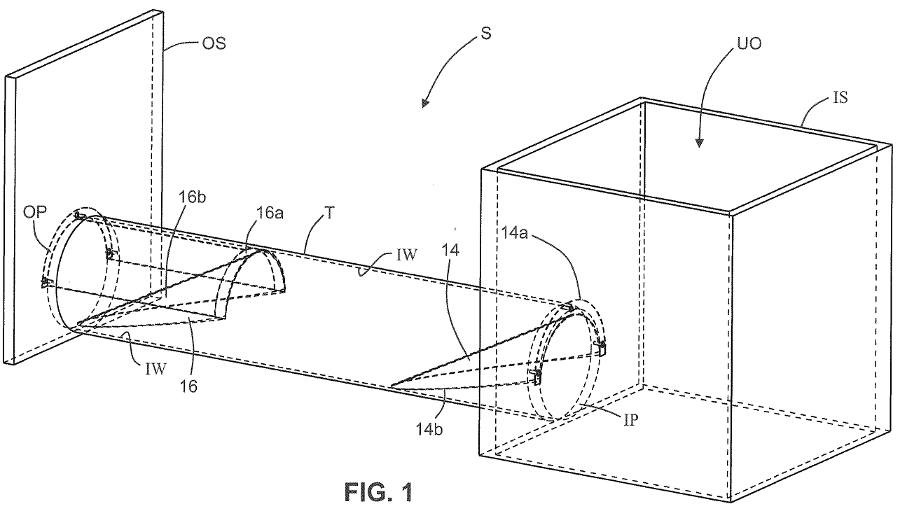

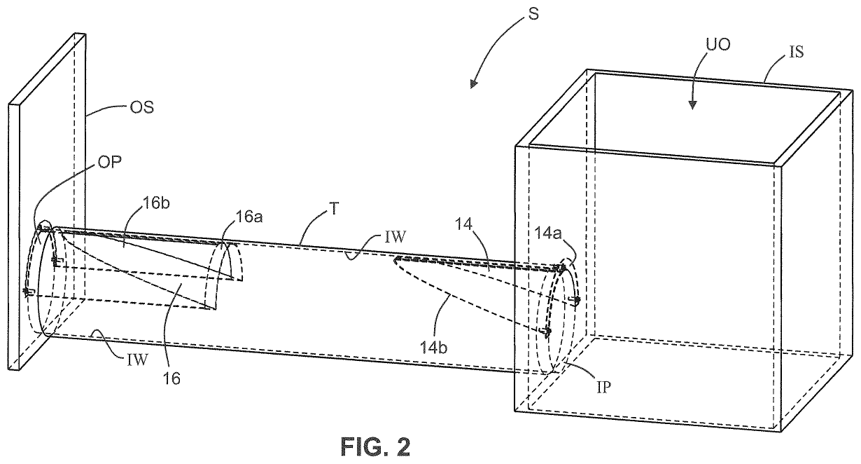

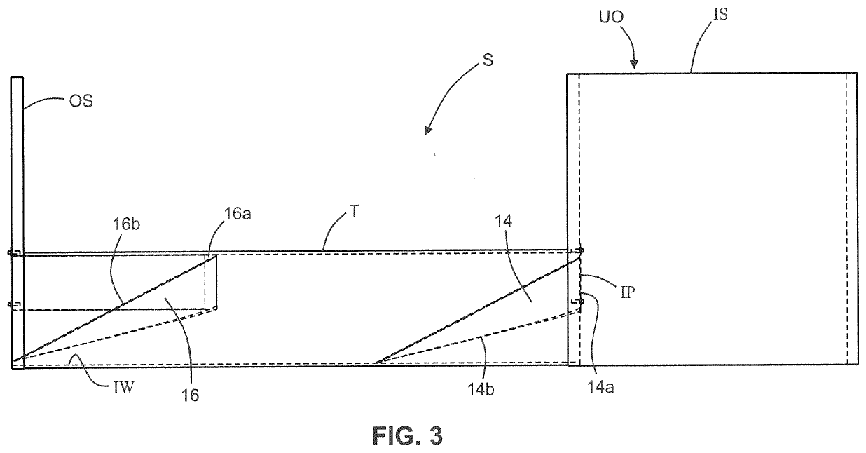

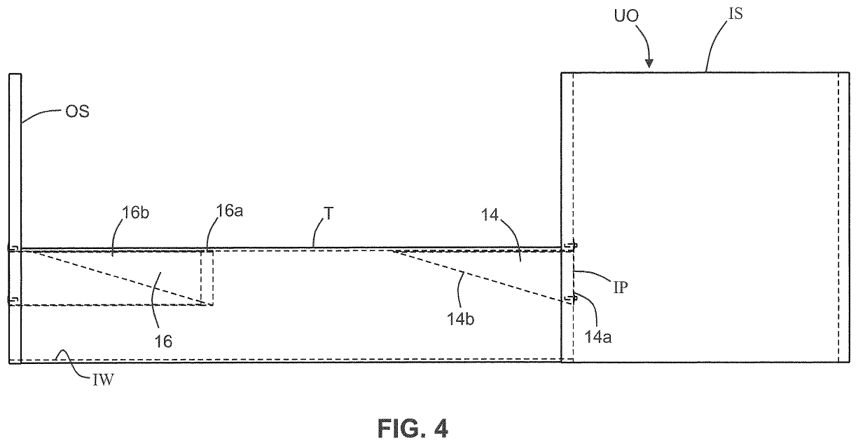

Referring to the drawings and particularly to FIGS. 1 through 4, one form of the apparatus of the invention for blocking the egress of hazardous matter in the form of hazardous gases from the tubular portion “T” a of a conventional storm water control system “S” is there shown as it appears when positioned within the storm water control system. This embodiment of the apparatus comprises a first yieldably deformable matter blocking barrier 14 that is connected to the inlet portion “IP” of the tubular portion “T”. Tubular portion “T” extends between the drain water inlet structure “IS” of the storm water control system and the drain water outlet structure “OS” of the system. Barrier 14, which can be constructed of various durable materials such as butyl rubber, includes a generally semicircular connector portion 14a that is connected to inlet portion “IP” and an elongate tapered portion 14b that extends into tubular portion “T” in the manner shown in FIGS. 1 and 3. Barrier 14 is movable between the first downwardly extending, blocking position shown in FIGS. 1 and 3 and a second upwardly extending, fluid flow position shown in FIGS. 2 and 4 of the drawings.

This first embodiment of the apparatus of the invention also comprises a second yieldably deformable barrier 16 that is connected to the inner wall “IW” of the tubular portion “T” in the manner shown in in FIGS. 1 through 4 of the drawings. Barrier 16, which is of similar construction to barrier 14 can also be constructed of various durable materials such as butyl rubber. Barrier 16 includes a semicircular connector portion 16a that is connected to inner wall “IW” and an elongate tapered portion 16b that is housed within tubular portion “T” in the manner shown in FIGS. 1 and 3. Barrier 16, like barrier 14, is movable between the first downwardly extending, blocking position shown in FIGS. 1 and 3 and a second upwardly extending, fluid flow position shown in FIGS. 2 and 4 of the drawings.

In accordance with one form of the method of the present invention, access to the inlet portion “IP” of tubular portion “T” is obtained via the upper opening “UO” of the storm water control system (FIG. 1) so that the barrier 14 can be connected to the tubular portion in the manner shown in FIGS. 1 through 4. In its at rest position, the body portion 14b of the barrier sealably engages the inner wall of the tubular portion in the manner shown in FIG. 1. In this position, barrier 14 effectively blocks the flow of hazardous and noxious gases outwardly of the inlet of the tubular portion and toward the opening of the inlet structure “IS”.

In a similar manner, barrier 16 is inserted into the outlet end of the tubular portion via outlet port “OP” in the manner shown in FIG. 1 so that it blocks the flow of gases outwardly there through. However, as illustrated in FIGS. 2 and 4 of the drawings, because of the flexibility of barriers 14 and 16, water flowing into the storm drain will cause the barriers to move into their second open position shown in FIGS. 2 and 4 allowing the fluid to flow freely through the tubular portion “T” and outwardly of the storm water control system.

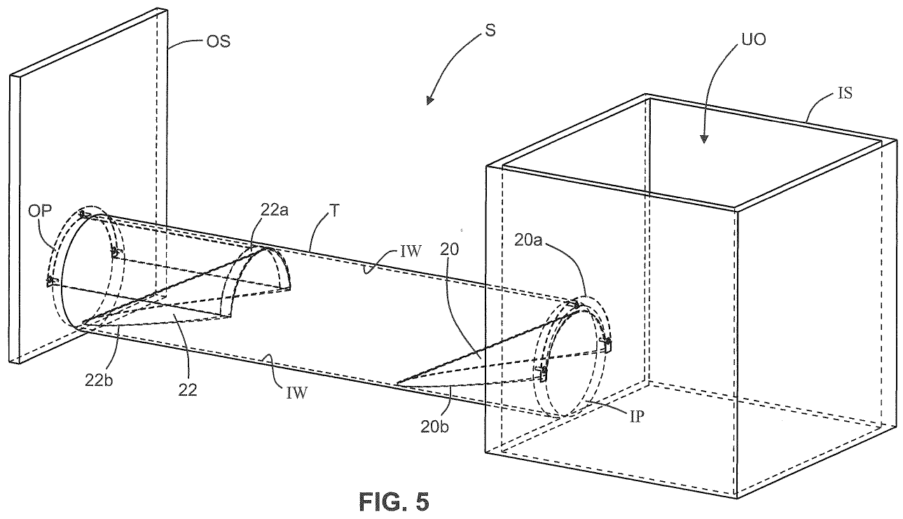

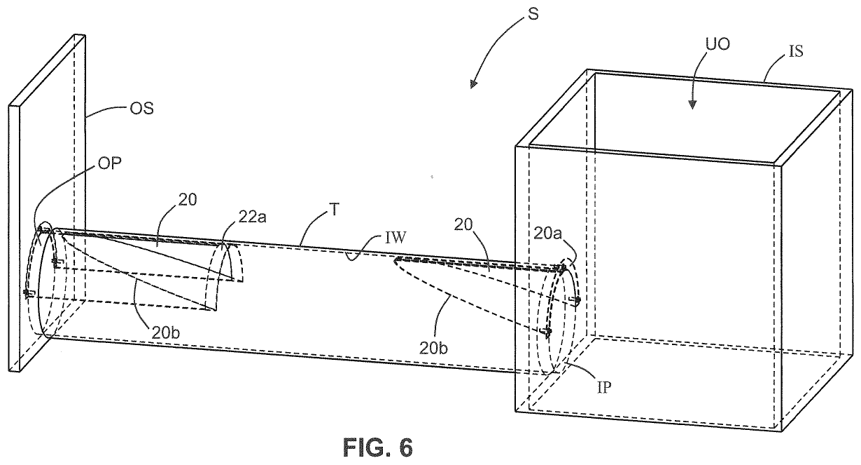

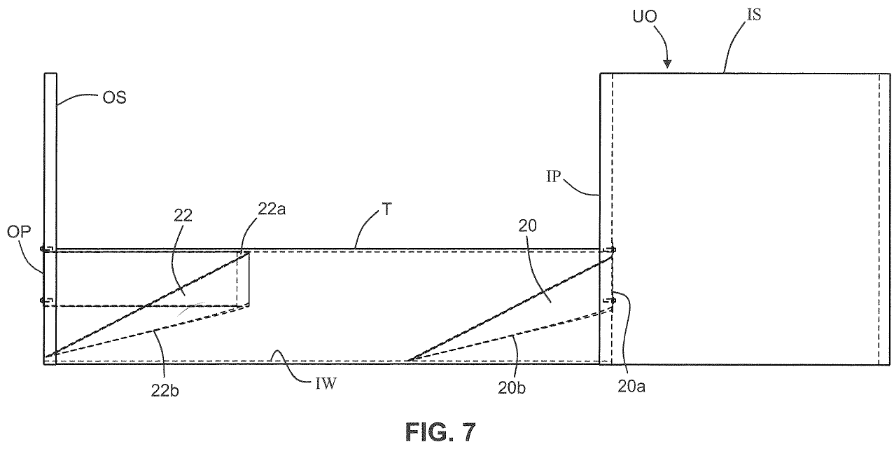

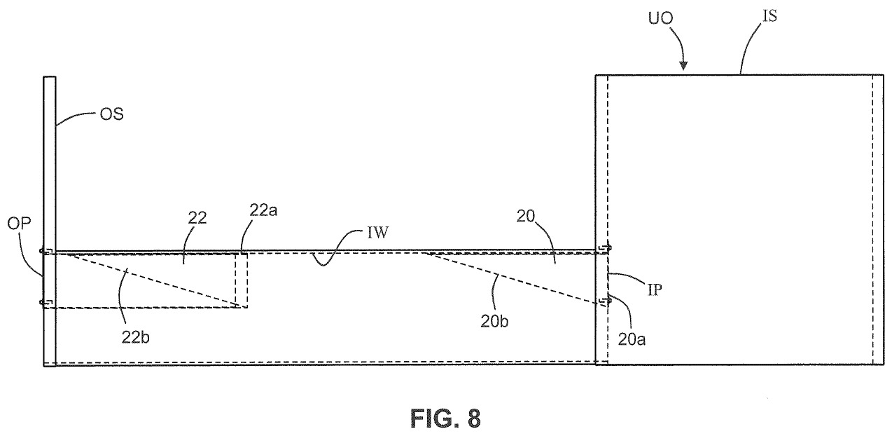

Referring now to FIGS. 5 through 8 of the drawings, another form of the apparatus of the invention is there shown. This embodiment concerns an apparatus for blocking the egress of insects from the tubular portion “T” of a conventional storm water control system “S”. The apparatus of this latest form of the invention comprises a first yieldably deformable porous barrier 20 that is connected to the inlet portion “IP” of the tubular portion “T”. As before, tubular portion “T” extends between the drain water inlet structure “IS” of the storm water control system and the drain water outlet structure “OS” of the system. Barrier 20, which can be constructed of various porous fabric and metal, includes a semicircular connector portion 20a that is connected to inlet portion “IP” and an elongate tapered portion 20b that extends into tubular portion “T” in the manner shown in FIGS. 5 and 7. Tapered portion 20b of barrier 20 comprises a yieldably deformable porous material having between about 280 and 800 perforations per square inch. Barrier 20 is movable between the first downwardly extending, blocking position shown in FIGS. 5 and 7 and a second upwardly extending, fluid flow position shown in FIGS. 6 and 8 of the drawings.

This second embodiment of the apparatus of the invention also comprises a second yieldably deformable barrier 22 that is connected to the inner wall “IW” of the tubular portion “T” in the manner shown in FIGS. 5 through 8 of the drawings. Barrier 22, which is of similar construction to barrier 20 can also be constructed of various porous materials such as fabrics and metal. Barrier 22 includes a semicircular connector portion 22a that is connected to inner wall “IW” and an elongate tapered portion 22b that is housed within tubular portion “T” in the manner shown in FIGS. 5 and 7. Tapered portion 22b like tapered portion 20b comprises a yieldably deformable porous material having between about 280 and 800 perforations per square inch. Barrier 22, like barrier 14, is movable between the first downwardly extending, blocking position shown in FIGS. 5 and 7 and a second upwardly extending, fluid flow position shown in FIGS. 6 and 8 of the drawings.

In accordance with another form of the method of the present invention, access to the inlet portion “IP” of tubular portion “T” is obtained via the upper opening “UO” of the storm water control system (FIG. 5) so that the barrier 20 can be connected to the tubular portion in the manner shown in FIGS. 5 through 8. In it's at rest position, the body portion 20b of the barrier sealably engages the inner wall of the tubular portion in the manner shown in FIG. 5. In this position, barrier 20 effectively blocks the movement toward the inlet of the tubular portion of insects, including mosquitoes and mosquito larvae that are residing in the debris housed within the tubular portion.

In a similar manner, barrier 22 is inserted into the outlet end of the tubular portion via outlet port “OP” in the manner shown in FIG. 5 so that it blocks the movement toward the outlet of the tubular portion of insects, including mosquitoes and mosquito larvae that are residing in the debris housed within the tubular portion. However, as illustrated in FIGS. 6 and 8 of the drawings, because of the flexibility of barriers 20 and 22, water flowing into the storm drain will cause the barriers to move into their second open position shown in FIGS. 6 and 8 allowing the fluid to flow freely through the tubular portion “T” and outwardly of the storm water control system.

It is to be understood that barriers 20 and 22 can selectively be constructed of various yieldably deformable porous materials such as fabrics and metal material having between about 280 and 800 perforations per square inch. Importantly, as shown in the drawings, both barriers 20 and 22 also include a semicircular connector portion and an elongate tapered portion.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention as set forth in the following claims.

I claim:

1. An apparatus for controlling the egress of hazardous matter from the inlet of the tubular drain portion of a storm water control system comprising a first blocking barrier connected to the tubular drain system for movement between a first position blocking egress of hazardous matter from the inlet of the tubular drain portion and a second position.

2. The apparatus as defined in claim 1 in which said first blocking barrier comprises a generally semicircular shaped connector portion and an elongated tail portion connected to said circular shaped connector portion.

3. The apparatus as defined in claim 1 in which said first blocking barrier comprises a butyl rubber.

4. The apparatus as defined in claim 1 in which said first blocking barrier comprises a porous material.

5. The apparatus as defined in claim 1 further including a second blocking barrier connected to the tubular drain system at a location spaced apart from said first blocking barrier, said second blocking barrier being movable between a first position and a second position.

6. The apparatus as defined in claim 5 in which said second blocking barrier comprises a generally semicircular shaped connector portion and an elongated tail portion connected to said circular shaped connector portion.

7. The apparatus as defined in claim 6 in which said second blocking barrier comprises a porous material.

8. The apparatus as defined in claim 7 in which said first blocking barrier comprises a butyl rubber.
